(19) United States
(12) Patent Application Publication
(10) Pub. No.: US 2009/0282957 A1
(43) Pub. Date: Nov. 19, 2009

(54) Reduction Unit for Lathe Feeders and Spindles

(76) Inventors: Pierantonio Melandri, Faenza (IT); Massimo Ragazzini, Faenza (IT); Renzo Romagnoli, Faenza (IT)

Correspondence Address: Modiano & Associati, Via Meravigli, 16, Milan, 20123, IT

(21) Appl. No.: 12/084,378

(22) PCT Filed: Nov. 24, 2006
(86) PCT No.: PCT/EP2006/068871

§ 371 Date: Apr. 30, 2008

(30) Foreign Application Priority Data
Nov. 28, 2005 (IT) BO2005A000717

(51) Int. Cl. B23B 13/08

(52) U.S. Cl. 82/163

(57) ABSTRACT

A reduction unit for feeders of lathes and spindles of lathes, which comprises a tubular body provided with at least one plate which is adapted to be coupled to a portion of one of the machines which control the unit, and a plurality of radially-acting elastic elements which are distributed on the internal surface of the body and protrude from it toward the inside of the body.

### BACKGROUND OF THE INVENTION

A feeder is a device designed for the controlled feeding of bars to the lathe: depending on the architecture of the lathe (single-spindle or multispindle), the feeder is shaped appropriately in order to guide the bars correctly up to the appropriate spindle of said lathe.

The apparatus constituted by the lathe and the feeder has the advantage of being substantially autonomous for long periods of operation (which depend on the speed of the work performed by the lathe and on the capacity of the bar magazine in the feeder).

Of course, if the bar is guided toward the spindle and into the spindle in an optimum manner, the vibration to which the entire apparatus is subjected is reduced (the bar does not warp) and work can be more precise.

The bars are directed toward the spindle by means of a guide which is provided at the rear with a bar pusher onto which the rear portion of the bar is clamped.

The diameter of the bar pusher is necessarily greater than the diameter of the bar, since it comprises a clamp which rigidly couples the rear end of the bar; the bar pusher must be able to pass through the guide (whose diameter is at least slightly greater than the maximum diameter of the bar pusher) until it passes through the spindle and substantially faces the end part of the spindle (part clamping region): the bar can thus oscillate and flex within the guide (as a consequence of the rotation to which it is subjected): the vibration generated by these movements can compromise some work (or in any case make it particularly complicated).

### SUMMARY OF THE INVENTION

The aim of the present invention is to obviate the above cited drawbacks and meet the mentioned requirements, by providing a reduction unit for lathe spindles and feeders which is adapted to guide the bar stably, preventing vibratory motions thereof and allowing at the same time the passage of the bar pusher.

Within this aim, an object of the present invention is to provide a reduction unit having a structure which is simple, relatively easy to provide in practice, safe in use, effective in operation and has a relatively low cost.

This aim and this and other objects which will become better apparent hereinafter are achieved by the present reduction unit for lathe feeders and spindles, characterized in that it comprises a tubular body provided with at least one plate which is suitable to be coupled to a portion of one of the machines which control said unit, and a plurality of radially-acting elastic means which are distributed on the internal surface of said body and protrude from it toward the inside of said body.

### BRIEF DESCRIPTION OF THE DRAWINGS

Further characteristics and advantages of the present invention will become better apparent from the following detailed description of a preferred but not exclusive embodiment of a reduction unit for lathe feeders and spindles, illustrated by way of non-limiting example in the accompanying drawings, wherein:

FIG. 1 is a partially sectional perspective view of a reduction unit for lathe feeders and spindles according to the invention;

FIG. 2 is an enlarged-scale perspective view of a portion of a reduction unit for lathe feeders and spindles according to the invention;

FIG. 3 is a front view of a reduction unit for lathe feeders and spindles according to the invention;

FIG. 4 is a perspective view of a lamina of a reduction unit for lathe feeders and spindles according to the invention;

FIG. 5 is a sectional side view of a feeder and a lathe which control a reduction unit according to the invention.

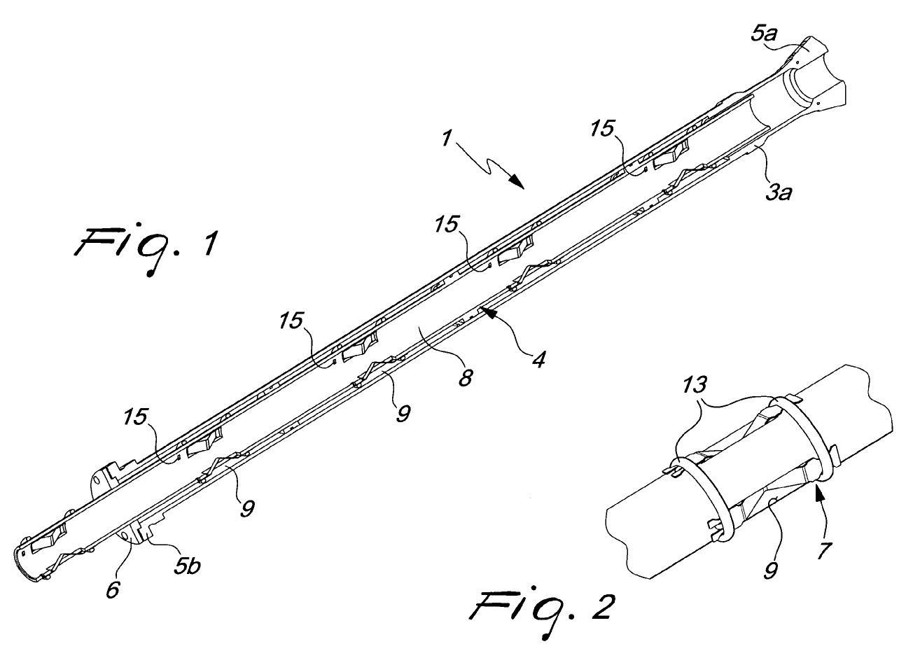

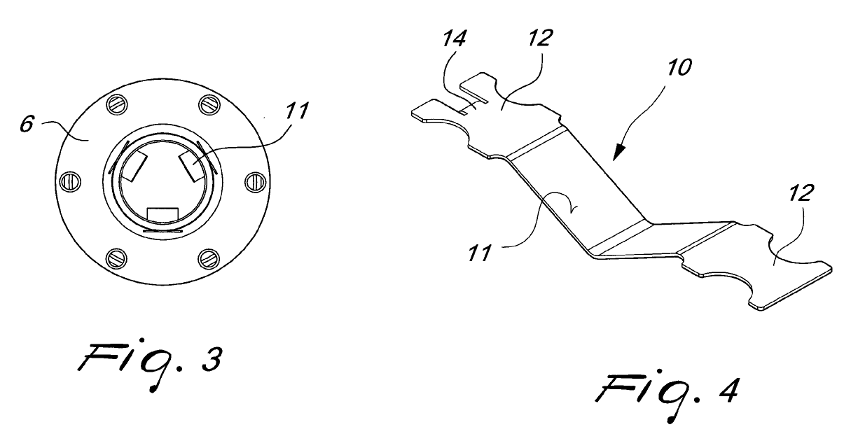

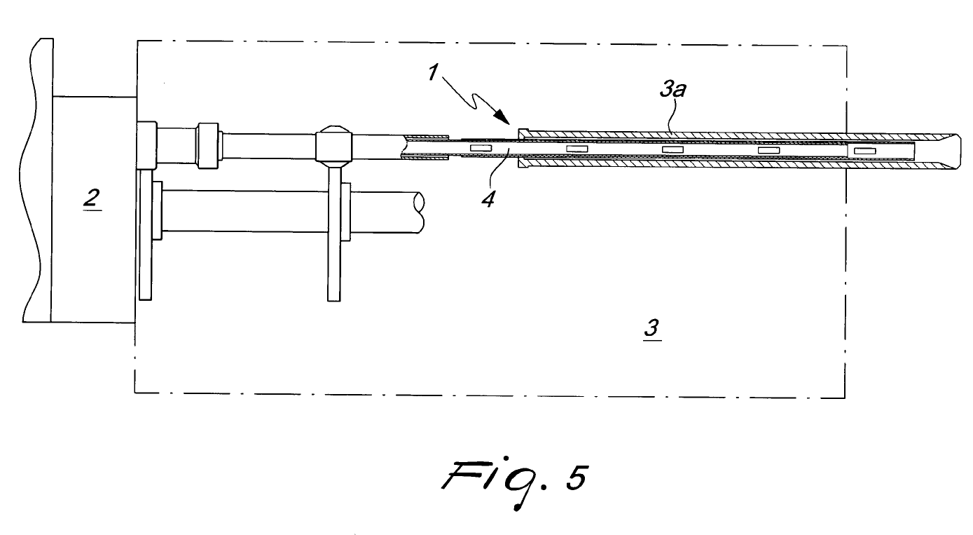

### DESCRIPTION OF THE PREFERRED EMBODIMENTS

With reference to the figures, the reference numeral 1 generally designates a reduction unit for spindles 3a of lathes 3 which is aligned with a feeder 2. The reduction unit 1 comprises a tubular body 4 whose length is suitable to run from an end portion of the feeder 2 (which generally lies inside the lathe 3) to the end of the spindle 3a of the lathe 3.

The spindle 3a is provided with at least one flange 5b, which is suitable to rigidly couple the reduction unit 1 according to the invention.

The reduction unit 1 according to the invention comprises a tubular element 4, which is rigidly coupled to a plate 6: the plate 6 can be coupled stably to the flange 5b of the spindle 3a.

The reduction unit 1 further comprises a plurality of radially-acting elastic means 7, which are distributed on an internal surface 8 of the body 4 and protrude from it toward the inside of the body 4.

According to a particularly simplified embodiment, the elastic means 7 can be two, which face each other so as to form a reduction of the internal cross-section of the tubular body 4: in particular, in this case, the facing and mutually proximate surfaces of two mutually opposite means 7 must be shaped so as to constitute a seat (facing concavities) within which a bar can be locked stably.

More generally, the mutually facing elastic means 7 are more than two, so that it is not necessary to shape their facing surfaces so as to constitute a concave seat: in the embodiment shown in the figure, it can be seen that it is possible to resort to three elastic means 7 arranged at 120° to each other, in practice constituting an elastically-acting centering element for the bar contained within the body 4.

The body 4 comprises a plurality of through openings 9 which are distributed and are suitable to accommodate at least one respective part of the elastic means 7: in the embodiment shown in the figure, each of the openings 9 is substantially rectangular. The mutual distance between the openings 9 (in an axial direction) depends on the intensity of the elastic centering action provided by the means 7: put simply, a very powerful action requires many elastic means 7 and therefore a substantially short distance between the openings.

The elastic means 7 comprise a contoured lamina 10, which is elastically deformable and is generally made of a metallic material having an evident elastic behavior, such as for example spring steel.

Each lamina 10 has a central V-shaped part 11, which is suitable to be accommodated within one of the through openings 9 of the tubular body 4.

The ends 12 of the lamina 10 are coplanar, and when the lamina 10 is installed within the respective through opening 9 they rest on the outer surface of the tubular body 4.

At each of the ends 12 which rest on the outer surface of the tubular body 4, the body 4 is surrounded by units for locking the ends 12 on the outer surface: in the embodiment shown in the figure, the locking units are constituted by elastic rings 13 whose diameter is suitable for clamping. The rings 13 can be constituted by actual metal springs or by toroidal elements made of elastically deformable polymeric material.

At least one of the two ends 12 of each lamina 10 comprises a protrusion 14 which is suitable for interlocking within a receptacle 15 provided in the tubular body 4 proximate to the respective through opening 9: the coupling between the receptacle 15 and the protrusion 14 is suitable to stably couple the lamina 10 to the body 4 in the presence of the elastic rings 13.

The V-shaped central part 11 of each lamina 10 protrudes radially toward the center of the tubular body 4 by a length which is at most equal to the internal radius of the tubular body 4.

Substantially, each bar which passes through the element 1 in order to reach the spindle 3a of the lathe 3 is guided correctly and kept axially aligned as a consequence of the elastic action performed by the means 7: the bar is pushed toward the spindle 3a by means of a bar pusher of the feeder 2, whose diameter is necessarily greater than the diameter of the bar and whose passage through the element 1 is allowed exclusively by the deformation of the elastic means 7. In this manner, the bar can be guided and pushed into the spindle 3a, avoiding vibrations and/or warping thereof.

It has thus been shown that the invention achieves the intended aim and object.

The invention thus conceived is susceptible of numerous modifications and variations, all of which are within the scope of the appended claims.

All the details may further be replaced with other technically equivalent ones.

In the embodiments that follow, individual characteristics, given in relation to specific examples, may actually be interchanged with other different characteristics that exist in other embodiments.

Moreover, it is noted that anything found to be already known during the patenting process is understood not to be claimed and to be the subject of a disclaimer.

In practice, the materials used, as well as the shapes and dimensions, may be any according to requirements without thereby abandoning the scope of the protection of the appended claims.

The disclosures in Italian Patent Application No. BO2005A000717 from which this application claims priority are incorporated herein by reference.

What is claimed is:

1-11. (canceled)

12. A reduction unit for feeders of lathes and spindles of lathes, comprising a tubular body provided with at least one plate which is adapted to be coupled to a portion of one of the machines which control said unit, and a plurality of radially-acting elastic means which are distributed on an internal surface of said body and protrude from it toward the inside of said body.

13. The unit of claim 12, wherein at least two of said elastic means face each other, forming a reduction in an internal cross-section of said tubular body.

14. The unit of claim 13, wherein said mutually facing elastic means are three and are arranged at 120° to each other.

15. The unit of claim 12, wherein said body comprises a plurality of distributed through openings, which are adapted to accommodate at least one respective part of said elastic means.

16. The unit of claim 15, wherein said elastic means comprise a contoured lamina, which is elastically deformable and has a central part which is V-shaped and is adapted to be accommodated within one of said through openings of said tubular body.

17. The unit of claim 16, wherein ends of said lamina are coplanar and, when the lamina is installed within a respective through opening, rest on an outer surface of said tubular body.

18. The unit of claim 17, wherein said body, at each of said ends which rest on the outer surface of said tubular body, is surrounded by units for locking the ends on the outer surface of said body.

19. The unit of claim 18, wherein said locking units are constituted by elastic rings whose diameter is adapted for clamping.

20. The unit of claim 19, wherein at least one of the two ends of each of said laminas comprises a protrusion which is adapted for interlocking within a receptacle provided in said tubular body proximate to the respective through opening, the coupling between the receptacle and the protrusion being adapted to stably couple the lamina to the body in the presence of said elastic rings.

21. The unit of claim 16, wherein a V-shaped central part of each of said laminas protrudes radially toward a center of the tubular body by a length which is at most equal to an internal radius of said tubular body.

22. The unit of claim 12, wherein said plate adapted to be rigidly coupled to a portion of one of the machines which control said element is an end portion for stably mounting on said feeder.
